(19) United States
(12) Patent Application Publication
(10) Pub. No.: US 2009/0028410 A1
(43) Pub. Date: Jan. 29, 2009

(54) ULTRASONIC IMAGING APPARATUS

(76) Inventor: Tadashi Shimazaki, Tokyo (JP)

Correspondence Address: PATRICK W. RASCHE (20459);ARMSTRONG TEASDALE LLP, ONE METROPOLITAN SQUARE, SUITE 2600, ST. LOUIS, MO, 63102-2740, US

(21) Appl. No.: 12/177,854

(22) Filed: Jul. 22, 2008

(30) Foreign Application Priority Data
Jul. 23, 2007 (JP) 2007-190482

(51) Int. Cl. G06K 9/78

(52) U.S. Cl. 382/131

(57) ABSTRACT

An ultrasonic imaging apparatus includes an image acquisition unit for acquiring tomographic image information of a subject on a real-time basis, a display unit for displaying the image of the tomographic image information, a DICOM server for storing and managing DICOM image information of the DICOM specification, a control unit for controlling the image acquisition unit and the DICOM server on a time-sharing basis, and an input unit for inputting the control information for the control.

### CROSS REFERENCE TO RELATED APPLICATIONS

This application claims the benefit of Japanese Patent Application No. 2007-190482 filed Jul. 23, 2007, which is hereby incorporated by reference in its entirety.

### BACKGROUND OF THE INVENTION

The subject matter disclosed herein is related to an ultrasonic imaging apparatus, which communicates image information via a communication line.

Recently, digital image information of patients treated in a hospital is significantly increasing due to the development of a variety of image diagnostic apparatus such as an X-ray CT. In addition, in order to perform the safe and efficient management of patient information, a LAN (local area network) is installed in the hospital to connect thereto the servers to allow centralized management of the patient information (see Japanese Unexamined Patent Publication no. 2002-269534, for example).

In order to systematically manage the digital image information of patients in the centralized management scheme, digital image information is standardized. The commonly used standard for such specification includes (Digital Imaging and Communications in Medicine). The DICOM standard is officially admitted by the NEMA (National Electrical Manufacturers Association). The digital image information in compliance with the DICOM standard and stored in a server may be displayed and observed by using a viewer, which primarily used for displaying images.

In a hospital a server may be installed for transmitting and receiving the DICOM standard digital image information to perform the centralized management of the digital image information on the server. The digital image information derived from an ultrasonic imaging apparatus will be converted to the DICOM format after imaging, and the image information in the DICOM format will be sent to the server to be subject to the centralized management.

However, in accordance with the above background technology, the comparison and investigation using the images of an ultrasonic imaging apparatus may not be efficient. More specifically, an operator needs to perform the imaging using the ultrasonic imaging apparatus, and thereafter uses a viewer placed in a remote location to compare the image information with the image information obtained by another image diagnostic apparatus such as an MRI or an X-ray CT in order to finally make a diagnosis.

An ultrasonic imaging apparatus, which is different from an MRI or an X-ray CT, has the advantage of small size and high portability, as well as is capable of obtaining tomographic images on a real-time basis. The above features allow an ultrasonic imaging apparatus to be moved to bedside to image and diagnose while an operator is facing a subject.

On the other hand, the comparison and investigation of images by using the viewer as cited above requires moving from the location of imaging to the location of comparison and investigation, resulting in spoiling the advantages of an ultrasonic imaging apparatus, such as the portability and the real-time basis.

It is therefore important to achieve an ultrasonic imaging apparatus that can easily perform comparison of images with the images of another image diagnostic apparatus while taking advantage of the portability of the apparatus and real-time capability of the images.

### BRIEF DESCRIPTION OF THE INVENTION

It is desirable that the problem described previously is solved.

An ultrasonic imaging apparatus in accordance with a first aspect includes: an image acquisition unit for acquiring tomographic image information of a subject on a real-time basis; a display unit for displaying the image of the tomographic image information; a DICOM server for storing and managing DICOM image information of the DICOM specification; a control unit for controlling the image acquisition unit and the DICOM server on a time-sharing basis; and an input unit for inputting the control information for the control.

The ultrasonic imaging apparatus in accordance with the first aspect has an image acquisition unit and a DICOM server controlled by a control unit.

In a second aspect, and according to the first aspect above, the control unit controls the acquisition and display of the tomographic image information on a real-time basis in a higher priority than the control of the DICOM server.

In the second aspect, the control of the DICOM server is performed in the idle-time in the control of the image acquisition unit.

In a third aspect and according to either the first or second aspect, the DICOM server includes an image specification conversion device for converting the tomographic image information to the DICOM image information.

In the third aspect, the tomographic image information obtained by the ultrasonic imaging apparatus is stored in a DICOM server.

In a fourth aspect, and according to the ultrasonic imaging apparatus set forth in any one of first to third aspects, the DICOM server includes a data management unit having list information, which collects the image supplementary information included in the DICOM image information.

In the fourth aspect the image information stored in the DICOM server is enumerated.

In a fifth aspect, and according to the ultrasonic imaging apparatus set forth in the fourth aspect, the input unit has a selection device for selecting DICOM image information in the DICOM server based on the list information.

In the fifth aspect the selection device allows selecting DICOM image information to be displayed.

In a sixth aspect, and according to the ultrasonic imaging apparatus set forth in the fifth aspect above, the display unit displays on a display screen the image of the selected DICOM image information.

In the sixth aspect, the image information stored in the DICOM server is extracted to observe.

In a seventh and according to the ultrasonic imaging apparatus set forth in the fifth aspect above, the display unit displays the image of the selected DICOM image information by the side of the image of the tomographic image information obtained on a real-time basis.

In the seventh aspect the tomographic image obtained by the ultrasonic imaging apparatus may be observed along with the image from another image diagnosis apparatus on the same display screen.

In an eighth aspect, and according to the ultrasonic imaging apparatus set forth in any one of first to seventh aspects above, the DICOM server includes a communication device for receiving and transmitting via a communication line the DICOM image information.

In the eighth aspect the image information derived from another image diagnosis apparatus may be stored into the DICOM server.

In a ninth aspect, and according to the ultrasonic imaging apparatus set forth in the eighth aspect above the communication device has a connector detachable with the communication line.

In the ninth aspect the connector allows the connection between the ultrasonic imaging apparatus and the communication line any time.

In a tenth aspect, and according to the ultrasonic imaging apparatus set forth in the eighth aspect above, the communication device has a wireless device which is capable of communicating by wireless with the communication line.

In the tenth aspect the wireless device allows the connection between the ultrasonic imaging apparatus and the communication line.

In an eleventh aspect, and according to the ultrasonic imaging apparatus set forth in any one of the eighth to tenth aspects above, the communication line is a local area network.

In a twelfth aspect, and according to the ultrasonic imaging apparatus set forth in any one of the first to eleventh aspects above, the control unit has an acquisition operation stop device for stopping the acquisition operation of the image acquisition unit.

In the twelfth aspect the control unit assigns longer chunk of time for the control of the DICOM server.

In a thirteenth aspect, and according to the ultrasonic imaging apparatus set forth in the twelfth aspect above, the input unit has an imaging pause key for generating the stop information for invoking the acquisition operation stop device.

In the thirteenth aspect the image acquisition operation may be easily stopped.

In a fourteenth aspect, and according to the ultrasonic imaging apparatus set forth in any one of the first to thirteenth aspects above, the control unit incorporates a multi-core CPU.

In the fourteenth aspect the control of the image acquisition unit is performed in a different CPU from the control of the DICOM server.

In a fifteenth aspect, and according to the ultrasonic imaging apparatus set forth in the fourteenth aspect above, the CPU has one core of the multi-core CPU used for controlling the image acquisition unit and the display unit, whereas another core used for controlling the DICOM server.

In a sixteenth aspect, and according to the ultrasonic imaging apparatus set forth in any one of the first to thirteenth aspects above, the DICOM server has a dedicated arithmetic processing unit.

In the sixteenth aspect the DICOM server has the image processing capability.

In accordance another embodiment, as the ultrasonic imaging apparatus has a DICOM server feature, the apparatus may be efficiently used as a server and a viewer when no image is captured. In addition in a clinical site where the ultrasonic imaging apparatus is moved in to perform the imaging, the image information of another image diagnosis apparatus stored in the DICOM server is also referred to for the comparison and investigation in order to achieve the most precise diagnosis on the site of imaging.

Further objects and advantages of the embodiments described herein will be apparent from the following description of the preferred embodiments as illustrated in the accompanying drawings.

### BRIEF DESCRIPTION OF THE DRAWINGS

FIG. 1 is a block diagram illustrating the configuration of an ultrasonic imaging apparatus.

FIG. 2 is a block diagram illustrating an exemplary image information system to which the ultrasonic imaging apparatus is connected.

FIG. 3 is a flow chart illustrating the operation of the ultrasonic imaging apparatus in accordance with the preferred embodiment.

FIG. 4 is a flow chart illustrating the operation of the image information transferring processing.

FIG. 5 is a flow chart illustrating the operation of the imaging and image comparison processing.

FIG. 6 is a schematic diagram illustrating an exemplary list display displayed on the display unit.

FIG. 7 is a schematic diagram illustrating the time-sharing control in the control unit in accordance with the preferred embodiment.

FIG. 8 is a schematic diagram illustrating two types of image information displayed side by side on the display unit.

FIG. 9 is an enlarged view of the part of the time-sharing control in the control unit for the imaging and image comparison processing.

### DETAILED DESCRIPTION OF THE INVENTION

Embodiments of an apparatus for achieving the ultrasonic imaging apparatus will be described in greater details herein below with reference to the accompanying drawings. It should be understood that the embodiments described herein are not considered to limit the invention.

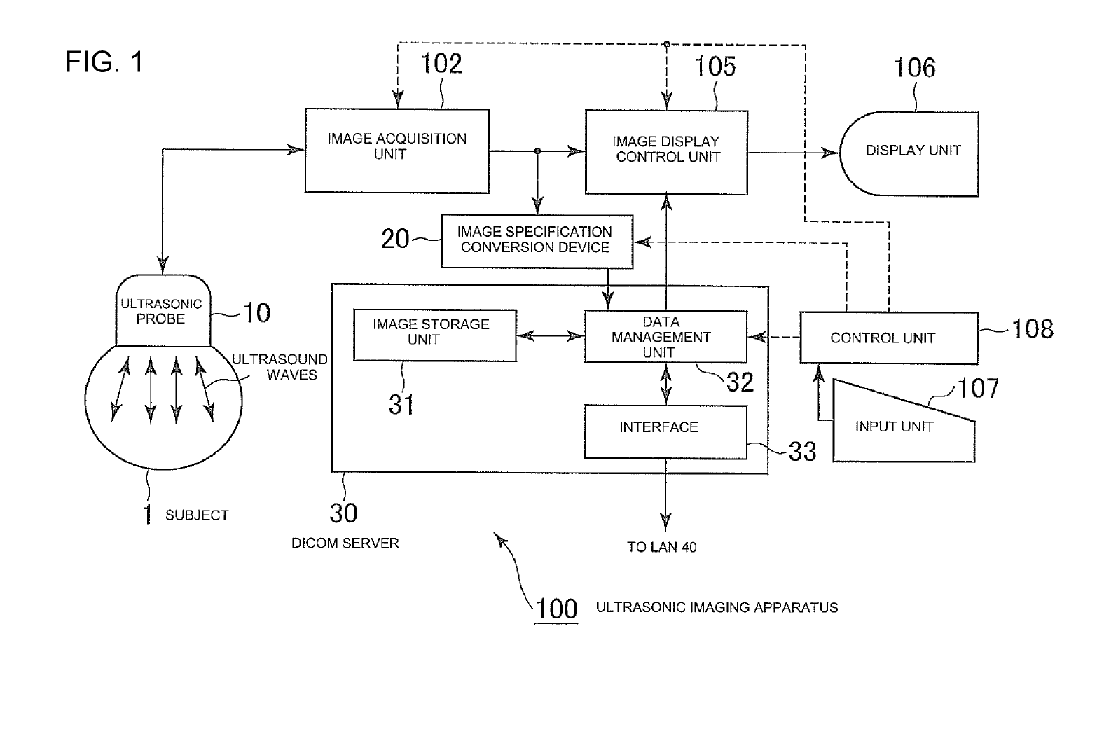

Now the overview of an exemplary ultrasonic imaging apparatus 100 will be described. Now referring to FIG. 1 there is shown a block diagram illustrating the whole configuration of the ultrasonic imaging apparatus 100. The ultrasonic imaging apparatus 100 includes an ultrasonic probe 10, an image acquisition unit 102, an image display control unit 105, a display unit 106, an input unit 107, an image specification conversion device 20, a DICOM server 30, and a control unit 108. The DICOM server 30 includes an image storage unit 31, a data management unit 32, and an interface 33.

The ultrasonic probe 10 is used for transmitting ultrasonic waves in a specified direction toward the imaging section of the subject 1 and for receiving the ultrasonic echoes reflected from the inside of the subject 1 as the time-series sound line.

The image acquisition unit 102 includes a transceiver unit, a B-mode processing unit, a cine memory, and the like. The transceiver unit is connected to the ultrasonic probe 10 with a coaxial cable and generates the electric signals for driving the piezoelectric elements in the ultrasonic probe 10. The transceiver unit also performs the first stage amplification of the received reflection ultrasonic echo signals.

The B-mode processing unit performs any necessary processing for real-time generation of a B-mode image from the reflection ultrasonic echo signals amplified by the transceiver unit. The cine memory is a type of image memory, which stores the B-mode image information generated by the B-mode processing unit.

The image display control unit 105 performs the display frame rate conversion of the B-mode image information generated by the B-mode processing unit as well as the shape and position control of the image display.

The display unit 106 is of a CRT (cathode ray tube) or an LCD (liquid crystal display), which is used for displaying the B-mode image and the image information stored in the DICOM server 30.

The input unit 107 includes a keyboard and a pointer, used for inputting the operation signals by the operator. The input unit 107 may be used for example for operational input of selecting the display status when imaging a B-mode image, and the information such as the scan starting will be transferred to the control unit 108.

The image specification conversion device 20 converts the tomographic image information obtained from the image acquisition unit 102 into the image information according to the DICOM specification, to store the image information in the DICOM server 30. In the conversion, the header information of the tomographic image information may be converted to that complying with the DICOM specification for storing.

The DICOM server 30 stores and manages the image information of DICOM specification. The image storage unit 31 is a mass storage memory, the data management unit 32 manages input/output of the image information stored in the image storage unit 31 and creates the list of stored contents. The interface 33, which is a communication device, has a connector not shown in the figure, and is connected to a LAN 40 via a cable connected to the connector.

The control unit 108 controls the components of the ultrasonic imaging apparatus described above based on the operation input signals from the input unit 107, and the program and data previously stored. The control unit 108 controls oil a time-sharing basis the image acquisition unit 102, the image display control unit 105, the image specification conversion device 20, and the DICOM server 30. The control unit 108 has the priority of control of the image acquisition unit and the image display control unit when performing the time-sharing control.

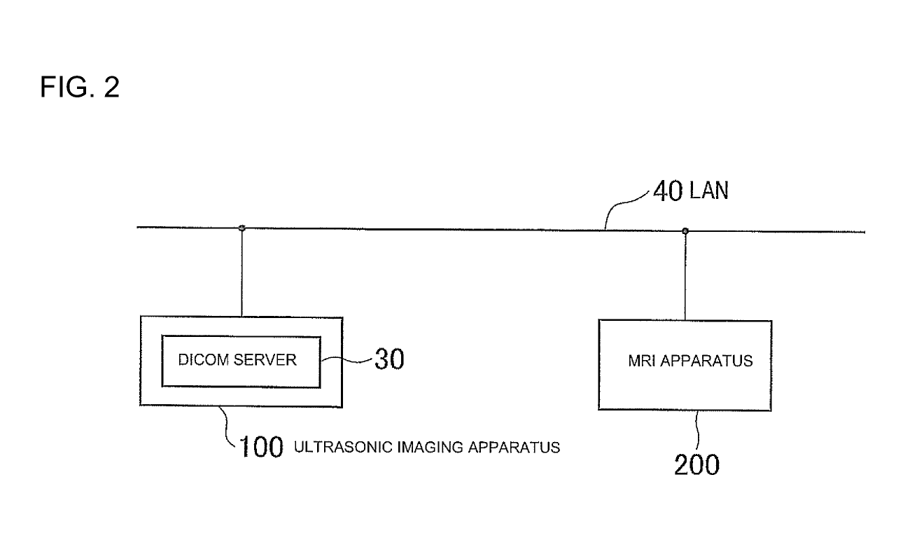

Now referring to FIG. 2 there is shown an exemplary image information system used in a hospital, to which the ultrasonic imaging apparatus 100 is connected. The image information system includes the ultrasonic imaging apparatus 100, the LAN 40, and the MRI (magnetic resonance imaging) apparatus 200. The ultrasonic imaging apparatus 100 includes the DICOM server 30, and is connected to the LAN 40 through the DICOM server 30.

The MRI apparatus 200 is an apparatus for acquiring tomographic image information by means of magnetic resonance. The operator mounts a subject lying on a cradle, then moves in the center of magnet generating static magnetic fields, to perform imaging. The magnets and cradle is installed within a shield room for magnetic shielding, and the operator on the operator console located outside the shield room performs the operation of imaging. The operator console has an image memory and is connected to the LAN 40 to transmit the image information complying with the DICOM specification. It should be noted here that the MRI apparatus 200 is an example of image diagnosis apparatus, and that any other image diagnosis apparatus such as an X-ray CT, a gamma camera, a PET (positron emission CT), an endoscope system may be connected to the LAN 40 to transmit the image information of DICOM specification.

The LAN 40 is a local area network installed in a hospital facility. The LAN 40 may communicate by means of a communication scheme such as CSMA/CD (Carrier Sense Multiple Access With Collision Detection).

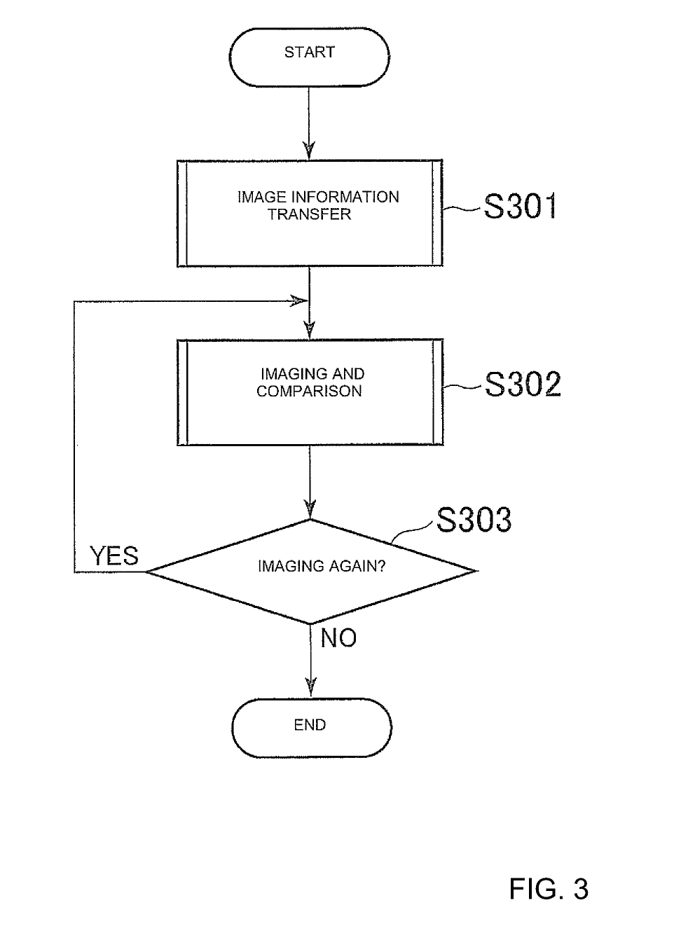

Now the operation of the ultrasonic imaging apparatus 100 will be described in greater details with reference to the flow charts shown in FIGS. 3 to 5. Now referring to FIG. 3 there is shown the main routine of the operation of the ultrasonic imaging apparatus 100. First, the operator initiates the image information transfer processing (step S301). In the image information transfer processing, the image information derived from another image diagnosis apparatus such as the MRI apparatus 200 is transferred to the DICOM server 30 of the ultrasonic imaging apparatus 100.

Then, the operator uses the ultrasonic imaging apparatus 100 to image the subject 1 and to compare the images (step S302). The ultrasonic imaging apparatus 100 in this step displays the acquired tomographic image together with the transferred image information for the comparison for investigation. The operator determines whether the imaging of the subject is performed once again or not, based on the comparison of images (step S303). When it is determined to perform imaging (step S303 affirmative), the process proceeds to the step S302. On the other hand, when it is determined not to perform imaging (step S303 negative), the process will terminate.

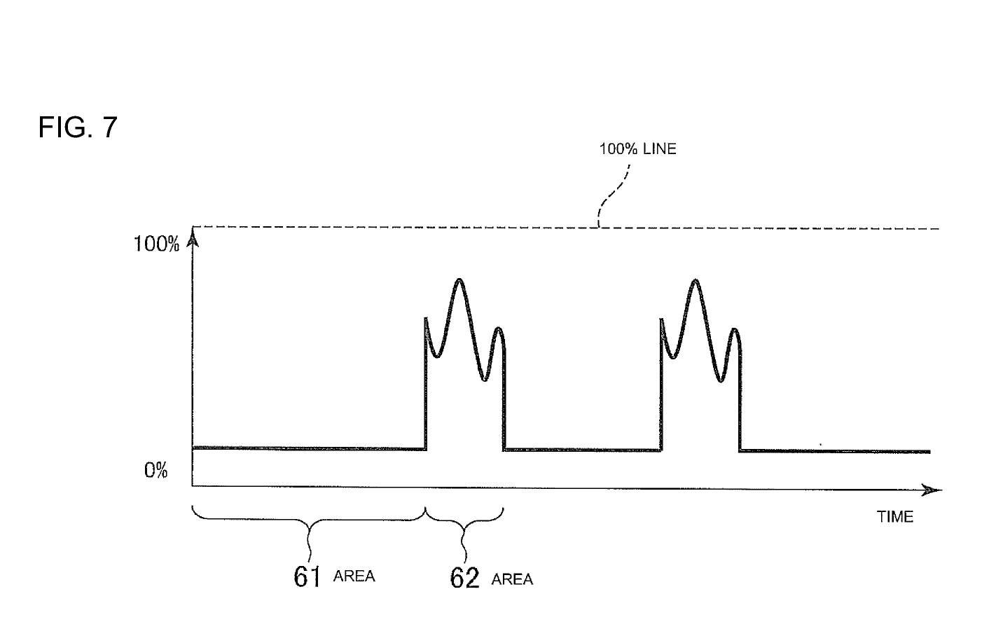

Now referring to FIG. 7 there is shown a detailed schematic diagram of the control unit 108 controlling the ultrasonic imaging apparatus 100 on the time-sharing basis, illustrating the time allocation of the control of the DICOM server 30 and the control of imaging. Since the control performed in the ultrasonic imaging apparatus 100 includes the control of the DICOM server 30 and the control of imaging, any one of those is always selected. In the figure the abscissa axis indicates the time, the ordinate axis indicates the percentage display of the time fraction of the control of imaging. The space between the line and the 100% line indicated on top of FIG. 7 indicates the time fraction of the idle-time usable for the control other than the imaging. In the idle-time, the control of the DICOM server 30 may be performed.

The area 61 shown in FIG. 7 has a smaller fraction of time for the control of imaging and the larger time fraction of time for the DICOM server 30 control. Since in the image transfer processing of the step S301 as have been described above no imaging is performed and the most of processing time is consumed for the transfer of image information to the DICOM server 30, the allocation of time is as shown in the area 61. In the area 62 the time allocation for the control of imaging occupies the most, and the time allocation for the control of the DICOM server 30 is a smaller fraction. In the imaging and comparison processing in the step S302 as have been described above, since the control of the image acquisition unit 102 and of the image display control unit 105 consumes the most of time, the time allocation is as shown in the area 62,

Now the image transfer processing of the step S301 and the imaging and image comparison processing of the step S302 will be described in greater details herein below.

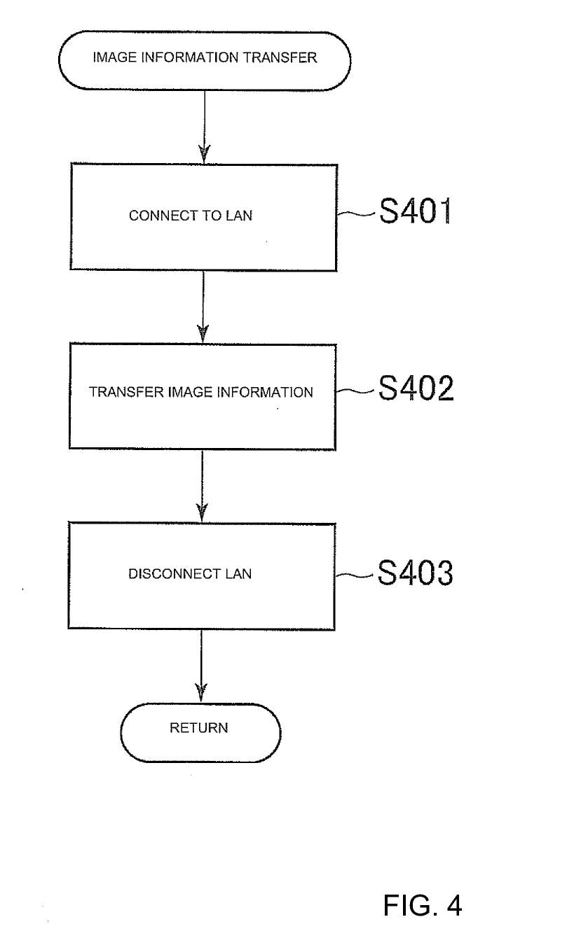

Now referring to FIG. 4 there is shown a flow chart indicating the operation of image information transfer processing in step S301. The operator relocates the ultrasonic imaging apparatus 100 to the place where a connection terminal of LAN 40 is provided, then connects the interface 33 that is the communication device of the DICOM server 30 with the LAN 40 through a cable (step S401). Next, the image information of DICOM specification stored in the image memory of the MRI apparatus 200 is transferred to the DICOM server 30 of the ultrasonic imaging apparatus 100 (step S402). Then the connection between the LAN 40 and the interface 33 of the DICOM server 30 is disconnected (step S403).

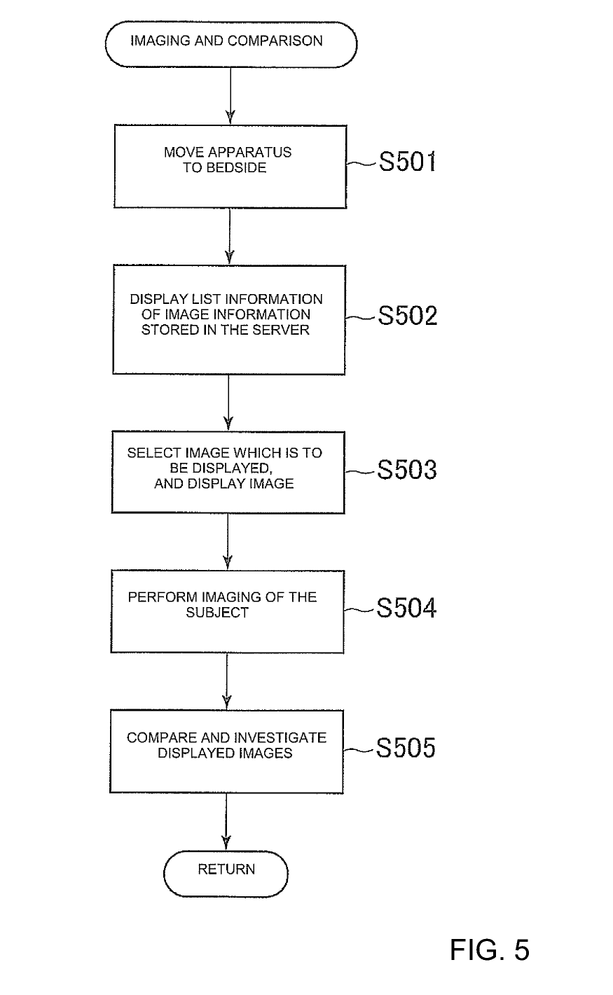

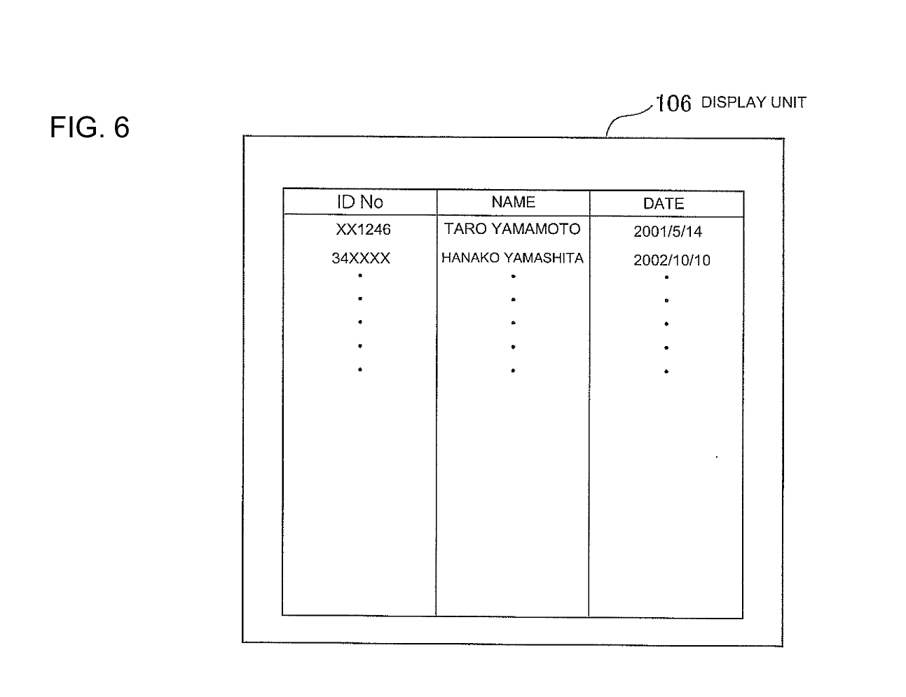

Now referring to FIG. 5 there is shown a flow chart illustrating the operation of the imaging and image comparison processing in step S302. The operator moves the ultrasonic imaging apparatus 100 near the bedside of the bed on which the subject 1 is lying (step S501). Then the operator displays on the display unit 106 the list of the image information stored in the DICOM server 30 (step S502). Now referring to FIG. 6 there is an example of the list information displayed on the display unit 106. The list information is stored in the data management unit 32, and is automatically extracted when reading from the supplementary information included for example in the header of the DICOM image information, and includes such as the ID No. of the DICOM image information, name of subject, the acquisition date and time of the image information, and the like.

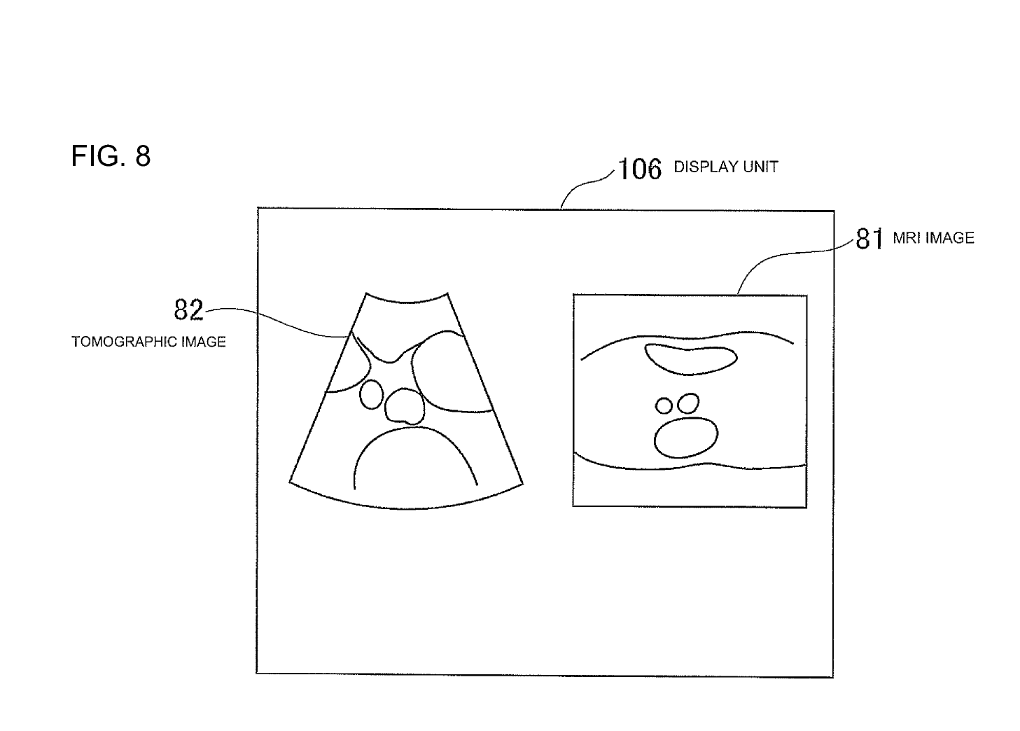

Thereafter, the operator selects and displays the image information to be displayed by means of a cursor based on the list information displayed (step S503). In this display, the transferred image information of for example the MRI apparatus 200 is display side by side along with the tomographic image information acquired on the real-time basis. Now referring to FIG. 8 there is shown a detailed schematic diagram illustrating an example of MRI image 81 displayed on the display unit 106. The MRI image 81 is displayed by the side of a tomographic image 82 acquired by the ultrasonic imaging apparatus 100. For the MRI image 81 an image of sectional position including the target imaging position of the imaging by the ultrasonic imaging apparatus 100 is selected.

Then, the operator uses the ultrasonic imaging apparatus 100 to image the subject 1 (step S504), compares the real-time tomographic image by the ultrasonic imaging apparatus 100 with the image by the MRI apparatus 200 and perform investigation (step S505). As shown in FIG. 8 the tomographic image 82 by the ultrasonic imaging apparatus 100 and the MRI image 81 by the MRI apparatus 200 are placed side by side, so that two different types of image information, which are derived from different imaging principles and are imaging the same imaging area within the subject 1, may be compared and investigated easily.

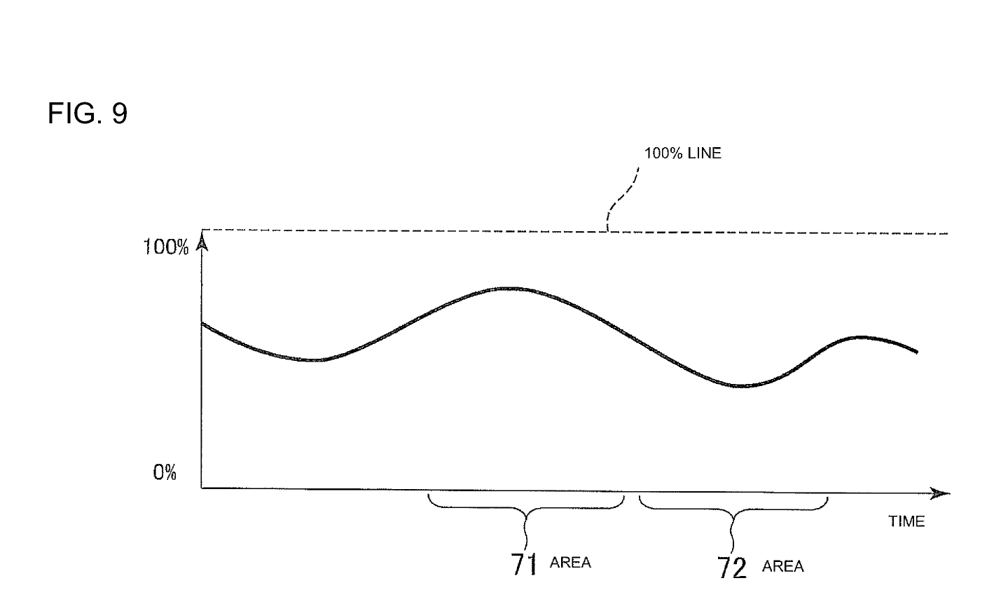

Now referring to FIG. 9 there is shown a detailed schematic diagram of the area 62 for the imaging and image comparison processing enlarged in the direction of time axis. The time allocated to the imaging processing varies depending on the time. The area 71 including the peak in the center is the fraction where the time allocated to the imaging control is the most, which is for example the case when imaging with the control of the image acquisition unit 102 being intensively performed. The area 72 away from the center peak is the fraction where the time allocated to the imaging control is decreased, which is for example the case when performing the control emphasizing on the image comparison.

As have been described above, in the preferred embodiment of the invention, the DICOM server 30 of the ultrasonic imaging apparatus 100 reads the image information derived from another image diagnosis apparatus and performs imaging using the ultrasonic imaging apparatus 100 at the bedside, while the acquired tomographic image information is displayed by the side of the image information selected from the DICOM server 30. Accordingly, the image comparison and investigation is easy to perform while referring to the past image information at the bedside, and to precisely diagnose on the site, and further, the time not used for the imaging is effectively employed as a server to increase the operation availability.

In the preferred embodiment of the invention, although the acquisition operation such as electronic scan by the image acquisition unit 102 is maintained during when the ultrasonic imaging apparatus 100 is operated as the DICOM server 30 alone, the acquisition operation including the scan may be completely stopped by providing an acquisition operation stop device for stopping the acquisition operation by the image acquisition unit 102 on the control unit and by pressing the imaging pause key separately located on the input unit 107. The rate of time-sharing control of the DICOM server 30 performed by the control unit may be increased near to 100% to allow enhancing the function as the server.

In the preferred embodiment of the invention, although the DICOM server 30 is connected to the LAN 40 through a cable connected to a connector provided in the interface 33 that is as the communication device, another wireless communication device may be provided to allow communication with the LAN 40 through a wireless device.

In the preferred embodiment of the invention, although the control unit 108 is comprised of a single core CPU, a multicore CPU may be alternatively used, and each core bears either the control of the DICOM server 30 or the imaging processing so that the control may be more efficiently performed.

In the preferred embodiment of the invention, although the tomographic image information acquired by the ultrasonic imaging apparatus 100 is displayed side by side along with the image information stored in the DICOM server 30, the tomographic image information acquired by the ultrasonic imaging apparatus 100 may be stored in the DICOM server 30, whereby the image may be displayed later side by side along with the image information obtained by another image diagnosis apparatus stored in the DICOM server 30.

In the preferred embodiment of the invention, although the image comparison and investigation is performed at the bedside in a hospital by using the ultrasonic imaging apparatus 100, the image comparison and investigation using the image information of the DICOM server 30 may also be performed anywhere the ultrasonic imaging apparatus 100 may be transported such as at the bedside in a home.

In the preferred embodiment of the invention, although the DICOM server 30 is controlled by the control unit 108 controlling the image acquisition unit 102, an additional arithmetic processing unit may be provided to the image storage unit 31 of the DICOM server 30. The image processing capability when using the DICOM server 30 as a viewer may be thereby enhanced.

In the preferred embodiment of the invention, the dedicated DICOM server attached to LAN 40 may be eliminated so as to reduce the total cost of an image information system in a hospital.

Many widely different embodiments of the invention may be configured without departing from the spirit and the scope of the present invention. It should be understood that the present invention is not limited to the specific embodiments described in the specification, except as defined in the appended claims.

1. An ultrasonic imaging apparatus, comprising:
an image acquisition unit configured to acquire tomographic image information of a subject on a real-time basis;
a display unit configured to display an image based on the tomographic image information;
a DICOM server configured to store and to manage DICOM image information based on a DICOM specification;
a control unit configured to control said image acquisition unit and said DICOM server on a time-sharing basis; and
an input unit configured to receive control information for said control unit.

2. An ultrasonic imaging apparatus according to claim 1, wherein said control unit is configured to control acquisition of the tomographic image information and display of the tomographic image information on a real-time basis in a higher priority than the control of said DICOM server.

3. An ultrasonic imaging apparatus according to claim 1, wherein said DICOM server comprises an image specification conversion device configured to convert the tomographic image information to the DICOM image information.

4. An ultrasonic imaging apparatus according to claim 1, wherein said DICOM server comprises a data management unit having list information, said data management unit configured to collect image supplementary information included in the DICOM image information.

5. An ultrasonic imaging apparatus according to claim 4, wherein said input unit comprises a selection device configured to select DICOM image information stored in said DICOM server based on the list information.

6. An ultrasonic imaging apparatus according to claim 5, wherein said display unit comprises a display screen configured to display an image of the selected DICOM image information.

7. An ultrasonic imaging apparatus according to claim 5, wherein said display unit is configured to display an image of the selected DICOM image information side-by-side with the image of the tomographic image information obtained on a real-time basis.

8. An ultrasonic imaging apparatus according to claim 1, wherein said DICOM server comprises a communication device configured to receive and to transmit the DICOM image information via a communication line.

9. An ultrasonic imaging apparatus according to claim 8, wherein said communication device comprises a connector configured to be detachable said communication line.

10. An ultrasonic imaging apparatus according to claim 8, wherein said communication device comprises a wireless device configured to wirelessly communicate with said communication line.

11. An ultrasonic imaging apparatus according to claim 8, wherein said communication line comprises a local area network.

12. An ultrasonic imaging apparatus according to claim 1, wherein said control unit comprises an acquisition operation stop device configured to stop the acquisition operation of said image acquisition unit.

13. An ultrasonic imaging apparatus according to claim 2, wherein said control unit comprises an acquisition operation stop device configured to stop the acquisition operation of said image acquisition unit.

14. An ultrasonic imaging apparatus according to claim 3, wherein said control unit comprises an acquisition operation stop device configured to stop the acquisition operation of said image acquisition unit.

15. An ultrasonic imaging apparatus according to claim 12, wherein said input unit comprises an imaging pause key configured to generate stop information for invoking said acquisition operation stop device.

16. An ultrasonic imaging apparatus according to claim 13, wherein said input unit comprises an imaging pause key configured to generate stop information for invoking said acquisition operation stop device.

17. An ultrasonic imaging apparatus according to claim 14, wherein said input unit comprises an imaging pause key configured to generate stop information for invoking said acquisition operation stop device.

18. An ultrasonic imaging apparatus according to claim 1, wherein said control unit comprises a multicore CPU.

19. An ultrasonic imaging apparatus according to claim 18, wherein said CPU comprises a first core configured to control said image acquisition unit and said display unit, a second core configured to control said DICOM server.

20. An ultrasonic imaging apparatus according to claim 1, wherein said DICOM server comprises a dedicated arithmetic processing unit.
